(19) United States
(12) Patent Application Publication
(10) Pub. No.: US 2003/0064254 A1
(43) Pub. Date: Apr. 3, 2003

(54) Siloxane resins

(76) Inventors: Katsuya Eguchi, Kanagawa (JP); Ronald Paul Boisvert, Midland, MI (US); Duane Raymond Bujalski, Auburn, MI (US); Pierre Maurice Chevalier, Penarth (GB); Duan-Li Ou, Barry (GB); Kai Su, Midland, MI (US)

Correspondence Address: Dow Corning Corporation, Intellectual Property Dept. - Mail CO1232, 2200 W. Salzburg Road, P.O. Box 994, Midland, MI, 48686-0994, US

(21) Appl. No.: 09/915,903

(22) Filed: Jul. 26, 2001

(51) Int. Cl. B32B 3/00; B32B 19/00; B32B 9/00; B32B 9/04; B32B 15/00; B32B 7/00

(52) U.S. Cl. 428/698; 428/209; 428/901

(57) ABSTRACT

This invention pertains to a siloxane resin composition comprising HSiO_{3/2} siloxane units, and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3. The siloxane resin contains a molar ratio of HSiO_{3/2} units to (R²O)_{b}SiO_{(4-b)/2} units of 0.5:99.5 to 99.5. The siloxane resin is useful to make insoluble porous resins and insoluble porous coatings. Heating a substrate with the siloxane resin at a sufficient temperature effects removal of the R²O groups to form an insoluble porous coating having a porosity in a range of 1 to 40 volume percent and a modulus in the range of 4 to 80 GPa.

### FIELD OF THE INVENTION

This invention pertains to a siloxane resin composition comprising HSiO_{3/2} siloxane units, and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3. This invention further pertains to insoluble porous resins and insoluble porous coatings produced from the siloxane resin composition.

### BACKGROUND OF THE INVENTION

Semiconductor devices often have one or more arrays of patterned interconnect levels that serve to electrically couple the individual circuit elements forming an integrated circuit (IC). The interconnect levels are typically separated by an insulating or dielectric coating. Previously, a silicon oxide coating formed using chemical vapor deposition (CVD) or plasma enhanced techniques (PECVD) was the most commonly used material for such dielectric coatings.

Dielectric coatings formed from siloxane-based resins have found use because such coatings provide lower dielectric constants than CVD or PECVD silicon oxide coatings and also provide other benefits such as enhanced gap filling, surface planarization and have a high resistance to cracking. It is desirable for such siloxane-based resins to provide coatings by standard processing techniques such as spin coating. A porous coating typically has a lower density than a corresponding solid coating.

In general, there are two types of dielectric coatings which serve as inter-layer dielectrics (ILD). The first type is a pre-metal dielectric material (PMD) formed before a metalization process is performed. The PMD serves as an insulating layer between the semiconductor component and the first metal layer. The second type of dielectric is an inter-metal dielectric (IMD), which is a dielectric layer interposed between low metallic layers for insulation.

Semiconductor processes for manufacturing integrated circuits often require forming a protective layer, or layers, to reduce contamination by mobile ions, prevent unwanted dopant diffusion between different layers, and isolate elements of an integrated circuit. Typically, such a protective layer is formed with silicon-based dielectrics, such as silicon dioxide, which may take the form of undoped silicate glass, borosilicate glass (BSG) or borphosphorous silicate glass (BPSG). If these dielectrics are disposed beneath the first metal layer of the integrated circuit, they are often referred to as pre-metal dielectrics.

Haluska, U.S. Pat. No. 5,446,088 describes a method of co-hydrolyzing silanes of the formulas HSi(OR)₃ and Si(OR)₄ to form co-hydrolysates useful in the formation of coatings. The R group is an organic group containing 1-20 carbon atoms, which when bonded to silicon through the oxygen atom, forms a hydrolyzable substituent. Especially preferred hydrolyzable groups are methoxy and ethoxy. The hydrolysis with water is carried out in an acidified oxygen containing polar solvent. The co-hydrolyzates in a solvent are applied to a substrate, the solvent evaporated and the coating heated to 50 to 1000° C. to convert the coating to silica. Haluska does not disclose silanes having branched alkoxy groups.

Smith et al., WO 98/49721, describe a process for forming a nanoporous dielectric coating on a substrate. The process comprises the steps of blending an alkoxysilane with a solvent composition and optional water; depositing the mixture onto a substrate while evaporating at least a portion of the solvent; placing the substrate in a sealed chamber and evacuating the chamber to a pressure below atmospheric pressure; exposing the substrate to water vapor at a pressure below atmospheric pressure and then exposing the substrate to base vapor.

Mikoshiba et al., U.S. Pat. No. 6,022,814, describe a process for forming silicon oxide films on a substrate from hydrogen or methyl siloxane-based resins having organic substituents that are removed at a temperature ranging from 250° C. to the glass transition point of the resin. Silicon oxide film properties reported include a density of 0.8 to 1.4 g/cm³, an average pore diameter of 1 to 3 nm, a surface area of 600 to 1,500 m²/g and a dielectric constant in the range of 2.0 to 3.0. The useful organic substituents that can be oxidized at a temperature of 250° C. or higher that were disclosed include substituted and unsubstituted alkyl or alkoxy groups exemplified by 3,3,3-triflouropropyl, 3-phenethyl, t-butyl, 2-cyanoethyl, benzyl, and vinyl.

Mikoskiba et al., J. Mat. Chem., 1999, 9, 591-598, report a method to fabricate angstrom size pores in methylsilsesquioxane coatings in order to decrease the density and the dielectric constant of the coatings. Copolymers bearing methyl (trisiloxysilyl) units and alkyl (trisiloxysilyl) units were spin-coated on to a substrate and heated at 250° C. to provide rigid siloxane matrices. The coatings were then heated at 450° C. to 500° C. to remove thermally labile groups and holes were left corresponding to the size of the substituents, having a dielectric constant of about 2.3. Trifluoropropyl, cyanoethyl, phenylethyl, and propyl groups were investigated as the thermally labile substituents.

Ito et al., Japanese Laid-Open Patent (HEI) 5-333553, describe preparation of a siloxane resin containing alkoxy and silanol functionality by the hydrolysis of diacetoxydi(tertiarybutoxy)silane in the presence of a proton acceptor. The resin is radiation cured in the presence of a photo acid with subsequent thermal processing to form a SiO₂ like coating and can be used as a photo resist material for IC fabrication.

It has now been found that incorporation of silicon bonded branched alkoxy groups (Si—OR²), where R² is an alkyl group having 3 to 30 carbon atoms, into siloxane resins provides several advantages such as improved storage stability, increased modulus and increased porosity of the cured resins. It is therefore an object of this invention to show a siloxane resin composition having improved storage stability. It is also an object of this invention to show a method for making siloxane resins and a method for curing these resins to produce insoluble coatings with a porosity from 1 to 40 volume percent, improved storage stability and higher modulus compared to resins containing primarily HSiO_{3/2} siloxane units. These insoluble porous coatings have the advantage that they may be formed using conventional thin film processing.

### SUMMARY OF THE INVENTION

This invention pertains to a siloxane resin composition comprising HSiO_{3/2} siloxane units, and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3. The siloxane resin contains a molar ratio of HSiO_{3/2} units to (R²O)_{b}SiO_{(4-b)/2} units of 0.5:99.5 to 99.5:0.5. The sum of HSiO_{3/2} units and (R²O)_{b}SiO_{(4-b)/2} units is at least 50 percent of the total siloxane units in the resin composition.

This invention also pertains to a method for making siloxane resins by reacting a silane or a mixture of silanes of the formula HSiX₃ and a silane or a mixture of silanes of the formula (R²O)_{c}SiX_{(4-c)}, where R² is independently selected from the group consisting of branched alkyl groups having 3 to 30 carbon atoms and substituted branched alkyl groups having 3 to 30 carbon atoms, c is from 1 to 3, and X is a hydrolyzable group or a hydroxy group.

This invention further pertains to a method of forming an insoluble porous resin and a method of forming an insoluble porous coating on a substrate. The porosity of the coating ranges from 1 to 40 volume percent. The insoluble porous coatings have a modulus in the range of 4 to 80 GPa.

### DETAILED DESCRIPTION OF THE INVENTION

The siloxane resin composition comprises HSiO_{3/2} siloxane units, and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3. The siloxane resin composition contains a molar ratio of HSiO_{3/2} units to (R²O)_{b}SiO_{(4-b)/2} units of 0.5:99.5 to 99.5 to 0.5. The sum of HSiO_{3/2} units and (R²O)_{b}SiO_{(4-b)/2} units is at least 50 percent of the total siloxane unit in the resin composition. It is preferred that the molar ratio of HSiO_{3/2} units to (R²O)_{b}SiO_{(4-b)/2} is 20:80 to 70:30 and that the sum of of HSiO_{3/2} units and (R²O)_{b}SiO_{(4-b)/2} units is at least 70 percent of the total siloxane units in the resin composition.

The structure of the siloxane resin is not specifically limited. The siloxane resins may be essentially fully condensed or may be only partially reacted (i.e., containing less than about 10 mole % Si—OR and/or less than about 30 mole % Si—OH). The partially reacted siloxane resins may be exemplified by, but not limited to, siloxane units such as HSi(X)_{d}O_{(3-d/2)} and Si(X)_{d}(OR²)_{f}O_{(4-d-f/2)}; in which R² is defined above; each X is independently a hydrolyzable group or a hydroxy group, and d and f are from 1 to 2. The hydrolyzable group is an organic group attached to a silicon atom through an oxygen atom (Si—OR) forming a silicon bonded alkoxy group or a silicon bonded acyloxy group. R is exemplified by, but not limited to, linear alkyl groups having 1 to 6 carbon atoms such as methyl, ethyl, propyl, butyl, pentyl, or hexyl and acyl groups having 1 to 6 carbon atoms such as formyl, acetyl, propionyl, butyryl, valeryl or hexanoyl. The siloxane resin may also contain less than about 10 mole % SiO_{4/2} units.

The siloxane resins have a weight average molecular weight in a range of 3,000 to 200,000 and preferably in a range of 8,000 to 150,000.

R² is a substituted or unsubstituted branched alkyl group having 3 to 30 carbon atoms. The substituted branched alkyl group can be substituted with substituents in place of a carbon bonded hydrogen atom (C—H). Substituted R² groups are exemplified by, but not limited to, halogen such as chlorine and fluorine, alkoxycarbonyl such as described by formula

—(CH₂)ₐC(O)O(CH₂)_{b}CH₃, alkoxy substitution such as described by formula —(CH₂)ₐO(CH₂)_{b}CH₃, and carbonyl substitution such as described by formula —(CH₂)ₐC(O)(CH₂)_{b}CH₃, where a≧0 and b≧0. Unsubstituted R² groups are exemplified by, but not limited to, isopropyl, isobutyl, sec-butyl, tert-butyl, isopentyl, neopentyl, tert-pentyl, 2-methylbutyl, 2-methylpentyl, 2-methylhexyl, 2-ethylbutyl, 2-ethylpentyl, 2-ethylhexyl, etc. Preferably R² is a tertiary alkyl having 4 to 18 carbon atoms and more preferably R² is t-butyl.

The method for preparing the siloxane resin comprises: combining

(a) a silane or a mixture of silanes of the formula HSiX₃, where X is independently a hydrolyzable group or a hydroxy group;

(b) a silane or a mixture of silanes of the formula (R²O)_{c}SiX_{(4-c)}, where R² is independently selected from the group consisting of branched alkyl groups having 3 to 30 carbon atoms and substituted branched alkyl groups having 3 to 30 carbon atoms, c is from 1 to 3, X is independently a hydrolyzable group or a hydroxy group;

(c) water; and

(d) a solvent,

for a time and temperature sufficient to effect formation of the siloxane resin.

Silane (a) is a hydridosilane or a mixture of hydridosilanes of the formula HSiX₃ where X is independently a hydrolyzable group or a hydroxy group. The hydrolyzable group is an organic group attached to a silicon atom through an oxygen atom (Si—OR) forming a silicon bonded alkoxy group or a silicon bonded acyloxy group. R is exemplified by, but not limited to, linear alkyl groups having 1 to 6 carbon atoms such as methyl, ethyl, propyl, butyl, pentyl, or hexyl and acyl groups having 1 to 6 carbon atoms such as formyl, acetyl, propionyl, butyryl, valeryl or hexanoyl. By “hydrolyzable group” it is meant that greater than 80 mole percent of X reacts with water (hydrolyzes) under the conditions of the reaction to effect formation of the siloxane resin. The hydroxy group is a condensable group in which at least 70 mole percent reacts with another X group bonded to a different silicon atom to condense and form a siloxane bond (Si—O—Si). It is preferred that silane (a) be trimethoxysilane or triethoxysilane because of their easy availability.

Silane (b) is an alkoxysilane or a mixture of alkoxysilanes of the formula (R²O)_{c}SiX_{(4-c)}, in which R² is independently an unsubstituted or substituted branched alkyl group having 3 to 30 carbon atoms as described above, X is independently a hydrolyzable group or a hydroxy group as described above, and c is from 1 to 3. It is preferred that silane (b) be di-t-butoxydihydroxysilane, di-t-butoxydiacetoxysilane, di-t-butoxydiethoxysilane and di-t-butoxydimethoxysilane because of their easy availability. Silane (a) and silane (b) are present in a molar ratio of silane (a) to silane (b) of 0.5:99.5 to 99.5:0.5. It is preferred that silane (a) and silane (b) are present in a molar ratio of silane (a) to silane (b) of 20:80 to 70:30.

Water is present in an amount to effect hydrolysis of the hydrolyzable group, X. Typically water is present in an amount of 0.5 to 2.0 moles of water per mole of X in silanes (a) and (b) and more preferably is when the water is 0.8 to 1.2 moles, on the same basis.

The solvent can include any suitable organic solvent that does not contain functional groups which may participate in the hydrolysis/condensation and is a solvent for silanes (a) and (b) and the siloxane resin prepared. The solvent is exemplified by, but not limited to, saturated aliphatics such as n-pentane, hexane, n-heptane, isooctane and dodecane; cycloaliphatics such as cyclopentane and cyclohexane; aromatics such as benzene, toluene, xylene and mesitylene; cyclic ethers such as tetrahydrofuran (THF) and dioxane; ketones such as methylisobutyl ketone (MIBK); halogen substituted alkanes such as trichloroethane; halogenated aromatics such as bromobenzene and chlorobenzene; and alcohols such as methanol, ethanol, propanol, butanol. Additionally, the above solvents may be used in combination as co solvents. Preferred solvents are aromatic compounds and cyclic ethers, with toluene, mesitylene and tetrahydrofuran being most preferred. The solvent is generally used within a range of 40 to 95 weight percent based on the total weight of solvent and silanes (a) and (b). More preferred is 70 to 90 weight percent solvent on the above basis.

Combining components (a), (b), (c) and (d) may be done in any order as long as there is contact between any hydrolyzable groups (X) and water, so that the reaction may proceed to effect formation of the siloxane resin. Generally the silanes are dissolved in the solvent and then the water added to the solution. Some reaction usually occurs when the above components are combined. To increase the rate and extent of reaction, however, various facilitating measures such as temperature control and/or agitation are utilized.

The temperature at which the reaction is carried out is not critical as long as it does not cause significant gelation or cause curing of the siloxane resin product. Generally the temperature can be in a range of 20° C. up to the reflux temperature of the solvent, with a temperature of 20° C. to 100° C. being preferred and 20° C. to 60° C. being more preferred. When X is an acyloxy group such as acetoxy, it is preferred to conduct the reaction at or below 40° C. The time to form the siloxane resin is dependent upon a number of factors such as, but not limited to, the specific silanes being used, the temperature and the mole ratio of HSiO and R²O desired in the siloxane resin product of the reaction. Typically, the reaction time is from several minutes to several hours. To increase the molecular weight of the siloxane resin prepared and to improve the storage stability of the siloxane resin it is preferred to carry out a bodying step subsequent to or as part of the above reaction. By “bodying” it is meant that the reaction is carried out over several hours with heating from 40° C. up to the reflux temperature of the solvent to effect the increase in weight average molecular weight. It is preferred that the reaction mixture be heated such that the siloxane resin after heating has a weight average molecular weight in the range of about 8,000 to 150,000.

When X is an acyloxy group such as acetoxy, the corresponding acid such as acetic acid is produced as a by-product of reaction. For example, since the presence of acetic acid may adversely affect the stability of the siloxane resin product, it is desirable that any acetic acid be neutralized. The acetic acid may be neutralized by contacting the reaction mixture with a neutralizing agent or by removal via distillation. The distillation is generally accomplished by the addition of solvent such as toluene (if it is not already present) and removing the acetic acid as an azeotrope with the solvent under reduced pressure and ambient temperature or heating up to 50° C. If a neutralizing agent is used, it must be sufficiently basic to neutralize any remaining acetic acid and yet insufficiently basic so that it does not catalyze rearrangement of the siloxane resin product. Examples of suitable bases include calcium carbonate, sodium carbonate, sodium bicarbonate, or calcium oxide. Neutralization may be accomplished by any suitable means such as stirring in a powdered neutralizing agent followed by filtration or by passing the reaction mixture and any additional solvent over or through a bed of particulate neutralizing agent of a size which does not impede flow. The bodying step described herein above, is generally carried out after neutralization and/or removal of the by-product acetic acid.

The siloxane resin may be recovered in solid form by removing the solvent. The method of solvent removal is not critical and numerous approaches are well known in the art. For example, a process comprising removing the solvent by distillation under vacuum at ambient temperature or heating up to 60° C. may be used. Alternatively, if it is desired to have the siloxane resin in a particular solvent, a solvent exchange may be done by adding a secondary solvent and distilling off the first solvent.

An insoluble porous resin may be obtained by heating the siloxane resin for a time and temperature sufficient to effect curing of the siloxane resin and removal of the R²O groups, thereby forming an insoluble porous resin. By “removal” it is meant that greater than about 80 mole percent of the R²O groups bonded to silicon atoms have been removed as volatile hydrocarbon and hydrocarbon fragments which generate voids in the coating, resulting in the formation of a porous resin. The heating may be conducted in a single-step process or in a two-step process. In the two-step heating process the siloxane resin is first heated for a time and temperature sufficient to effect curing without significant removal of the R²O groups. Generally this temperature can be in a range of from greater than 20° C. to 350° C. for several minutes to several hours. Then the cured siloxane resin is further heated for a time and temperature (for several minutes to several hours) within a range of greater than 350° C. up to the lesser of the decomposition of the siloxane resin backbone or the hydrogen atoms bonded to silicon of the HSiO_{3/2} siloxane units to effect removal of the R²O groups from the silicon atoms. Typically, the removal step is conducted at a temperature in a range of greater than 350° C. to 800° C. If it is desired to retain higher levels of SiH after cure, up to 50% SiH retained, it is preferred that the removal step be conducted at a temperature in a range of greater than 350° C. to 600° C., with 400° C. to 550° C. being more preferred. The porosity and level of SiH in the final insoluble porous resin can be controlled by the mole percent of OR² in the siloxane resin and how the siloxane resin is heated. For example heating as rapidly as possible to temperatures above 650° C. results in essentially no SiH present in the insoluble porous resin.

In the single-step process the curing of the siloxane resin and removal of the R²O groups are effected simultaneously by heating for a time and temperature within a range of greater than 20° C. up to the lesser of the decomposition of the siloxane resin backbone or the hydrogen atoms bonded to silicon atoms described herein above to effect removal of the R²O groups from the cured siloxane resin. Generally, if it is desired to retain higher levels of SiH after cure (up to 50% SiH retained), it is preferred that the curing/removal step be conducted at a temperature in a range of greater than 350° C. to 600° C., with a temperature in a range of 400° C. to 550° C. being most preferred.

It is preferred that the heating takes place in an inert atmosphere, although other atmospheres may be used. Inert atmospheres useful herein include, but are not limited to, nitrogen, helium and argon with an oxygen level less than 50 parts per million and preferably less than 15 parts per million. Heating may also be conducted at any effective atmospheric pressure from vacuum to above atmospheric and under any effective oxidizing or non-oxidizing gaseous environment such as those comprising air, O₂, oxygen plasma, ozone, ammonia, amines, moisture, N₂O, hydrogen, etc.

The insoluble porous resins may be useful as porous materials with controllable porosity and high temperature stability up to 750° C. such as shape selective gas or liquid permeable membranes, catalyst supports, energy storage systems such as batteries and molecular separation and isolation. By the term “porous” it is meant an insoluble porous resin having a porosity in a range of from 1 to 40 volume percent. The modulus of the insoluble porous resins ranges from about 4 to 80 GPa.

The siloxane resins may be used to prepare a coating on a substrate by:

(A) coating the substrate with a coating composition comprising a siloxane resin composition comprising HSiO_{3/2} siloxane units, and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3. The siloxane resin contains an average molar ratio of HSiO_{3/2} units to (R²O)_{b}SiO_{(4-b)/2} units of 0.5:99.5 to 99.5 to 0.5. The sum of HSiO_{3/2} units and (R²O)_{b}SiO_{(4-b)/2} units is at least 50 percent of the total siloxane units in the resin composition;

(B) heating the coated substrate for a time and temperature sufficient to effect curing of the coating composition, and

(C) further heating the coated substrate for a time and temperature sufficient to effect removal of the R²O groups from the cured coating composition, thereby forming an insoluble porous coating on the substrate.

The siloxane resin is typically applied to a substrate as a solvent dispersion. Solvents which may be used include any agent or mixture of agents which will dissolve or disperse the siloxane resin to form a homogeneous liquid mixture without affecting the resulting coating or the substrate. The solvent can generally be any organic solvent that does not contain functional groups, such as a hydroxy group, which may participate in a reaction with the siloxane resin exemplified by those discussed herein above for the reaction of the silane mixture with water.

The solvent is present in an amount sufficient to dissolve the siloxane resin to the concentration desired for a particular application. Typically the solvent is present in an amount of about 40 to 95 weight percent, preferably from 70 to 90 weight percent based on the weight of the siloxane resin and solvent. If the siloxane resin has been retained in a solvent described herein above, the solvent may be used in coating the substrate, or if desired a simple solvent exchange may be performed by adding a secondary solvent and distilling off the first solvent.

Specific methods for application of the siloxane resin to a substrate include, but are not limited to spin coating, dip coating, spray coating, flow coating, screen printing or others. The preferred method for application is spin coating. When a solvent is used, the solvent is allowed to evaporate from the coated substrate resulting in the deposition of the siloxane resin coating on the substrate. Any suitable means for evaporation may be used such as simple air drying by exposure to an ambient environment, by the application of a vacuum, or mild heat (up to 50° C.) or during the early stages of the curing process. When spin coating is used, the additional drying method is minimized since the spinning drives off the solvent.

Following application to the substrate, the siloxane resin coating is heated for a time and temperature sufficient to effect cure of the siloxane resin and removal of the R²O groups bonded to silicon atoms, thereby forming a porous coating. By “cured coating” it is meant that the coating is converted to an insoluble coating that is essentially insoluble in the solvent from which the siloxane resin was deposited onto the substrate or any solvent delineated above as being useful for the application of the siloxane resin. By “removal” it is meant that greater than about 80 mole percent of the R²O groups bonded to silicon atoms have been removed as volatile hydrocarbon and hydrocarbon fragments which generate voids in the coating, resulting in the formation of a porous resin.

The heating may be conducted in a single-step process or in a two-step process. In the two-step heating process the siloxane resin is first heated for a time and temperature sufficient to effect curing without significant removal of the R²O groups. Generally this temperature can be in a range of from greater than 20° C. to 350° C. for several minutes to several hours. Then the cured siloxane resin coating is further heated for a time and temperature (for several minutes to several hours) within a range of greater than 350° C. up to the lesser of the decomposition of the siloxane resin backbone or the hydrogen atoms bonded to silicon of the HSiO_{3/2} siloxane units to effect removal of the R²O groups from the silicon atoms. Typically, the removal step is conducted at a temperature in a range of greater than 350° C. to 800° C. If it is desired to retain higher levels of SiH after cure, up to 50% SiH retained, it is preferred that the removal step be conducted at a temperature in a range of greater than 350° C. to 600° C., with 400° C. to 550° C. being more preferred.

The porosity and level of SiH in the final insoluble coating can be controlled by the mole percent of R² in the siloxane resin and how the siloxane resin as applied to a substrate and heated. For example heating as rapidly as possible to temperatures above 650° C. results in essentially no SiH present in the insoluble porous coating.

In the single-step process the curing of the siloxane resin and removal of the R²O groups are effected simultaneously by heating for a time and temperature within a range of greater than 20° C. up to the lesser of the decomposition of the siloxane resin backbone or the hydrogen atoms bonded to silicon atoms described herein above to effect removal of the R²O groups from the cured coating composition. Generally, if it is desired to retain higher levels of SiH after cure (up to 50% SiH retained), it is preferred that the curing/removal step be conducted at a temperature in a range of greater than 350° C. to 600° C., with a temperature in a range of 400° C. to 550° C. being most preferred.

It is preferred that the heating takes place in an inert atmosphere, although other atmospheres may be used. Inert atmospheres useful herein include, but are not limited to, nitrogen, helium and argon with an oxygen level less than 50 parts per million and preferably less than 15 parts per million. Heating may also be conducted at any effective atmospheric pressure from vacuum to above atmospheric and under any effective oxidizing or non-oxidizing gaseous environment such as those comprising air, O₂, oxygen plasma, ozone, ammonia, amines, moisture, N₂O, hydrogen, etc.

Any method of heating such as the use of a quartz tube furnace, a convection oven, or radiant or microwave energy is generally functionally herein. Similarly, the rate of heating is generally not a critical factor, but it is most practical and preferred to heat the coated substrate as rapidly as possible.

The insoluble porous coatings produced herein may be produced on any substrate. However, the coatings are particularly useful on electronic substrates. By “electronic substrate” it is meant to include silicon based devices and gallium arsenide based devices intended for use in the manufacture of a semiconductor component including focal plane arrays, opto-electronic devices, photovoltaic cells, optical devices, transistor-like devices, 3-D devices, silicon-on-insulator devices, super lattice devices and the like.

By the above method a thin (less than 5 μm) insoluble porous coating is produced on the substrate. Preferably the insoluble porous coatings have a thickness of 0.3 to 2.5 μm and a thickness of 0.5 to 1.2 μm being more preferable. The coating smoothes the irregular surfaces of the various substrates and has excellent adhesion properties.

Additional coatings may be applied over the insoluble porous coating if desired. These can include, for example SiO₂ coatings, silicon containing coatings, silicon carbon containing coatings, silicon nitrogen containing coatings, silicon oxygen nitrogen containing coatings, silicon nitrogen carbon containing coatings and/or diamond like coatings produced from deposition (i.e. CVD, PECVD, etc.) of amorphous SiC:H, diamond, silicon nitride. Methods for the application of such coatings are known in the art. The method of applying an additional coating is not critical, and such coatings are typically applied by chemical vapor deposition techniques such as thermal chemical vapor deposition (TCVD), photochemical vapor deposition, plasma enhanced chemical vapor deposition (PECVD), electron cyclotron resonance (ECR), and jet vapor deposition. The additional coatings can also be applied by physical vapor deposition techniques such as sputtering or electron beam evaporation. These processes involve either the addition of energy in the form of heat or plasma to a vaporized species to cause the desired reaction, or they focus energy on a solid sample of the material to cause its deposition.

The insoluble porous coatings formed by this method are particularly useful as coatings on electronic devices such is integrated circuits. By the term “porous” it is meant an insoluble coating having a porosity in a range of from 1 to 40 volume percent. The modulus of the insoluble porous coatings range from about 4 to 80 GPa.

### EXAMPLES

The following non-limiting examples are provided so that one skilled in the art may more readily understand the invention. In the Examples weights are expressed as grams (g). Molecular weight is reported as weight average molecular weight (Mw) and number average molecular weight (Mn) determined by Gel Permeation Chromatography. Analysis of the siloxane resin composition was done using ²⁹Si nuclear magnetic resonance (NMR). Nitrogen sorption porosimetry measurements were performed using a QuantaChrome Autosorb 1 MP system. The cured siloxane resins were ground into fine powders before being placed into the sample cell, degassed for several hours, and loaded into the analysis station. The surface area was determined by the Brunauer-Emmett-Teller (BET) method. The total pore volume was determined from the amount of vapor adsorbed into the pores at a relative pressure close to unity (P/Po=0.995) with the assumption that the pores filled with adsorbate. Skeletal density was measured using a helium gas pycnometer. Skeletal density represents the true density of the siloxane resin solid structure excluding any interior voids, cracks or pores in the measurement. The percent porosity was calculated from the skeletal density and the total pore volume. Refractive Index (RI) and coating thickness were measured using a Woollam M-88 Spectroscopic Ellipsometer.

In the following examples Me stands for methyl and tBu stands for tertiary-butyl, AcO stands for acetoxy, and Et stands for ethyl. In the following tables, n.m. indicates the specified property was not measured.

### Example 1

This example illustrates the formation of a siloxane resin composition where R² is t-butyl. 10.00 g of (HO)₂Si(OtBu)₂ and 5.56 g of HSi(OMe)₃ were added to 22.00 g of tetrahydrofuran (THF) in a flask equipped under an argon atmosphere. 1.69 g of deionized water was then added slowly to the reaction mixture at room temperature. After stirring at room temperature for 90 minutes, the reaction mixture was heated to reflux for 5.5 hours. The solvent was removed using a rotary evaporator to yield 8.00 g siloxane resin as a solid. Composition as determined by ²⁹Si NMR was (HSiO_{3/2})_{0.25}((tBuO)_{b}SiO_{4-b/2})_{0.75} with a Mw of 6,090 and Mn of 4,500.

### Example 2

This example illustrates the formation of an insoluble porous resin where R² is t-butyl. 1.45 g of the siloxane resin prepared in Example 1 was weighed into an alumina crucible and transferred into a quartz tube furnace. The furnace was evacuated to <20 mmHg (<2666 Pa) and backfilled with argon. The sample was heated to 450° C. at a rate of 10° C./minute and held at 450° C. for 1 hour before cooling to room temperature while under an argon purge. The cured material was obtained in 52.9 weight percent yield (0.78 g). BET surface area was 602 m²/g and pore volume was 0.388 cc/g. The composition as determined by ²⁹Si NMR was (HSiO_{3/2})_{0.14} (SiO_{4/2})_{0.86}.

### Example 3

This example illustrates the formation of a siloxane resin composition where R² is t-butyl. HSi(OEt)₃ (A), and (AcO)₂Si(OtBu)₂ (B) were added to 72.0 g THF in a flask under an argon atmosphere in the amounts described in Table 1. Deionized water was then added to the flask and the mixture was stirred at room temperature for 1 hour. 75 g of toluene was added to the reaction mixture. The solvent was removed using a rotary evaporator to yield the product as viscous oil, which was immediately dissolved into 150 g of toluene. By-product acetic acid was removed as an azeotrope with toluene under reduced pressure by heating to 38° C. The resin was again dissolved into 110 g of toluene and azeotropically dried under reflux for 1 h. using a dean stark trap to remove the water formed (to body the resin and build up molecular weight). The solution was filtered and the solvent removed by evaporation to yield the final resin product. A summary of the resin synthesis is shown in Table 1. Analysis of the siloxane resins is shown in Table 2.

TABLE 1
Summary of Resin Synthesis

| Example | (A) | (B) | H₂O | Yield | |
|---|---|---|---|---|---|
| No. | (g) | (g) | (g) | (g) | Appearance |
| 3-1 | 5.67 | 40.2 | 6.1 | 23.7 | Gum |
| 3-2 | 11.23 | 30.0 | 6.65 | 18.7 | Gum |
| 3-3 | 16.85 | 20.0 | 7.2 | 15.4 | Solid |
| 3-4 | 26.20 | 20.0 | 10.0 | 19.2 | Gum |

TABLE 2
Analysis of (HSiO_{3/2})_{f}((tBuO)_{b}SiO_{4-b/2})_{g} Resins.

| | Molar ratio of f/g | Molar ratio of f/g | | |
|---|---|---|---|---|
| Example | Based on reactants | Based on ²⁹Si NMR | Mn | Mw |
| 3-1 | 0.20/0.80 | 0.21/0.79 | 2,920 | 8,650 |
| 3-2 | 0.40/0.60 | 0.43/0.57 | 6,750 | 25,800 |
| 3-3 | 0.60/0.40 | 0.62/0.38 | 7,010 | 147,000 |
| 3-4 | 0.70/0.30 | n.m. | n.m. | n.m. |

### Example 4

This example illustrates the formation of a porous resin where R² is t-butyl. Samples of the resins from example 3 (2 to 3 g) were weighed into an alumina crucible and transferred into a quartz tube furnace. The furnace was evacuated to <20 mmHg (<2666 Pa) and backfilled with argon. The samples were heated to 450° C. at a rate of 10° C./minute and held at 450° C. for 1 hour before cooling to room temperature while under an argon purge. The cured siloxane resins were obtained as transparent or slightly opaque thick films. The pyrolysis temperature, Char Yield and porosity data are shown in Table 3. Char Yield is expressed as weight percent retained after analysis at the specified temperature.

TABLE 3
Porosity and char yields of cured resins.

| | Resin | Skeletal | Char | Pore | | Surface |
|---|---|---|---|---|---|---|
| Example | Sample | Density | Yield | Volume | Porosity | Area, |
| No. | No. | (g/cm³) | (Wt %) | (cm³/g) | (%) | BET, (m²/g) |
| 4-1 | 3-1 | 1.970 | 45.8 | 0.313 | 38.1 | 550 |
| 4-2 | 3-2 | 1.982 | 51.4 | 0.317 | 38.6 | 559 |
| 4-3 | 3-3 | 1.787 | 65.0 | 0.224 | 28.6 | 392 |

### Example 5

This example illustrates the formation of porous coatings on a substrate where R² is a t-butyl group. Samples of the resins from example 3 (2 to 3 g) were dissolved in MIBK to form a clear solution containing 25 weight % as resin. The solution was filtered through a 1.0 μm syringe membrane filter followed by a 0.2 μm syringe membrane filter to remove any large particles. The solution was applied to a silicon wafer by spin coating at 2000 rpm for 20 seconds. The coated silicon wafers were put into a quartz tube furnace and the furnace was purged with nitrogen. The furnace was heated to 450° C. (50° C. to 6⁰° C./minute) and held at temperature for 2 hours, then cooled to room temperature while maintaining the nitrogen purge. The coated wafers were stored under a nitrogen atmosphere before the property measurements. Modulus and dielectric constants (Dk) of the thin films are shown in Table 4. This example demonstrates an unexpected increase in mechanical strength as indicated by higher modulus of the insoluble porous coating by incorporating t-butoxy groups in the siloxane resin compared to a non-porous insoluble coating from a hydrogen silsesquioxane resin.

TABLE 4
Thin film Properties of resins on silicon wafers

| | Resin | | | | | |
|---|---|---|---|---|---|---|
| Example | Sample | | Modulus, | Hardness, | Thickness, | |
| No. | No. | Dk | Gpa | Gpa | Å | RI |
| 5-1 | 3-1 | 24.3 | 18.6 | 0.88 | 4,180 | 1.321 |
| 5-2 | 3-2 | 14.9 | 16.1 | 0.77 | 4,120 | 1.355 |
| 5-3 | 3-3 | 6.34 | 10.8 | 1.06 | 6,590 | 1.290 |

As a comparative example, a sample of a hydrogen silsesquioxane resin prepared by the method of Collins et al., U.S. Pat. No. 3,615,272 was also evaluated as described above. The resulting nonporous thin film had a Dk of 2.9 and a modulus of 5.8.

### Example 6

This example illustrates the formation of a siloxane resin composition where R² is t-butyl. HSi(OEt)₃ (58.1 g), and (AcO)₂Si(OtBu)₂ (240.4 g) were added to THF (440.5 g) in a flask under an argon atmosphere. Deionized water (44.0 g) was then added to the flask over 14 minutes and the mixture was stirred at room temperature for 1 hour. Toluene (400.5 g) was added to the reaction mixture and the diluted product was condensed to high solids on a rotary evaporator (33° C.). Toluene (500.0 g) was again added and the product was again condensed to high solids on a rotary evaporator (33° C.). Toluene (720.9 g) was added a final time and the product solution was then bodied for 1 hour (107° C.) at a solids concentration of 20 weight percent after removal of 214 grams of volatiles. The cooled product solution was filtered and stripped using a rotary evaporator at 33° C. then 25° C. under 1 mm vacuum to yield 124.5 grams of a soluble gum. Theoretical resin composition based upon reactants is (HSiO_{3/2})_{0.30}((tBuO)_{b}SiO_{4-b/2})_{0.70} and the composition Based on ²⁹Si NMR was (HSiO_{3/2})_{0.26}((tBuO)_{b}SiO_{4-b/2})_{0.74}.

### Example 7

This example illustrates the formation of porous coatings on a substrate using high temperature (700° C.) where R² is a t-butyl group. Samples of the resin from example 6 were dissolved in MIBK to prepare a solution as 25 weight percent resin. The solution was filtered through a 1.0 μm syringe membrane filter followed by a 0.2 μm syringe membrane filter to remove any large particles. The solution was applied to silicon wafers by spin coating at 2000 rpm for 20 seconds. The coated silicon wafers were put into a quartz tube furnace and cured under the following conditions:

(1) under a nitrogen atmosphere (nitrogen flow rate of 20 L/min.). The furnace was heated to 700° C. (at 25° C./minute) and held for 30 minutes, then cooled to room temperature while maintaining the nitrogen flow. The coated wafers were stored under a nitrogen atmosphere. Film properties are shown in Table 5.

(2) under a wet oxidative environment. The coated silicon wafers were purged with nitrogen at room temperature for 5 minutes, followed by heating under an oxygen (O₂) atmosphere to 680° C. (at 25C/minute). Heating was continued to 700° C. (at 4° C./minute) while introducing steam to the purge (24 g/min.) and held at 700° C. for 30 minutes while maintaining oxygen and steam flow. The furnace was cooled to room temperature at 25° C./minute under a nitrogen atmosphere. The coated wafers were stored under a nitrogen atmosphere. Film properties are shown in Table 5.

TABLE 5
Film Properties of resins on silicon wafers

| Example | | | Modulus | Hardness | Residual SiOH | Thickness | |
|---|---|---|---|---|---|---|---|
| No. | Cure | Dk | (Gpa) | (Gpa) | (mole %) | (Å) | RI |
| 7-1 | (1) | 4.79 | 15.2 | | 1.270 | 3,690 | 1.3063 |
| 7-2 | (2) | n.m. | 29.0 | 1.68 | 1.208 | 3,340 | 1.3450 |

FTIR analysis of the films showed the structure to be SiO₂. No SiH was detected in any of the samples.

What is claimed is:

1. A siloxane resin composition comprising HSiO_{3/2} siloxane units and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3, the siloxane resin composition contains a molar ratio of HSiO_{3/2} units to (R²O)_{b}SiO_{(4-b)/2} units of 0.5:99.5 to 99.5:0.5 and the sum of HSiO_{3/2} units and (R²O)_{b}SiO_{(4-b)/2} units is at least 50 percent of the total siloxane units in the siloxane resin composition.

2. The siloxane resin composition as claimed in claim 1, wherein the average molar ratio of HSiO_{3/2} units to (R²O)_{b}SiO_{(4-b)/2} is 20:80 to 70:30 and the sum of HSiO_{3/2} units and (R²O)_{b}SiO_{(4-b)/2} units is at least 70 percent of the total siloxane units in the resin composition.

3. The siloxane resin composition as claimed as in claim 1, wherein R² is a tertiary alkyl group having 4 to 18 carbon atoms.

4. The siloxane resin composition as claimed as in claim 1, wherein R² is t-butyl.

5. A method for preparing a siloxane resin comprising HSiO_{3/2} siloxane units and (R²O)_{b}SiO_{(4-b)/2} siloxane units where b is from 1 to 3, which comprises: combining
(a) a silane or a mixture of silanes of the formula HSiX₃, where X is independently a hydrolyzable group or a hydroxy group;
(b) a silane or a mixture of silanes of the formula (R²O)_{c}SiX_{(4-c)}, where R² is independently selected from the group consisting of branched alkyl groups having 3 to 30 carbon atoms and substituted branched alkyl groups having 3 to 30 carbon atoms, c is from 1 to 3, X is independently a hydrolyzable group or a hydroxy group, silane (a) and silane (b) are present in a molar ratio of silane (a) to silane (b) of 0.5:99.5 to 99.5:0.5;
(c) water; and
(d) a solvent,
for a time and temperature sufficient to effect formation of the siloxane resin.

6. The method as claimed as in claim 5, wherein R² is a tertiary alkyl group having 4 to 18 carbon atoms.

7. The method as claimed as in claim 5, wherein R² is t-butyl.

8. The method as claimed in claim 5, wherein the water is present in a range from 0.5 to 2.0 moles of water per mole of X in silane (a) and silane (b).

9. The method as claimed in claim 5, wherein the water is present in a range from 0.8 to 1.2 moles of water per mole of X in silane (a) and silane (b).

10. A method of forming an insoluble porous resin, which comprises:
(A) heating the siloxane resin of claim 1 for a time and temperature sufficient to effect curing of the siloxane resin,
(B) further heating the siloxane resin for a time and temperature sufficient to effect removal of the R²O groups from the cured siloxane resin, thereby forming an insoluble porous resin.

11. The method as claimed in claim 10, where the heating in step (A) is from greater than 20° C. to 350° C. and the further heating in step (B) is from greater than 350° C. to 600° C.

12. The method as claimed in claim 10, where the heating in step (B) is from 450° C. to 550° C.

13. The method as claimed in claim 10, where the curing of the siloxane resin and removal of the R²O groups from the cured siloxane resin is done in a single step.

14. The method as claimed in claim 10, wherein the insoluble porous resin has a porosity from 1 to 40 volume percent and a modulus from 4 to 80 GPa.

15. A method of forming an insoluble porous coating on a substrate comprising the steps of
(A) coating the substrate with a coating composition comprising a siloxane resin composition comprising HSiO_{3/2} siloxane units and (R²O)_{b}SiO_{(4-b)/2} siloxane units wherein R² is independently selected from the group consisting of branched alkyl groups having 3 to 30 carbon atoms and substituted branched alkyl groups having 3 to 30 carbon atoms, b is from 1 to 3, the siloxane resin composition contains a molar ratio of HSiO_{3/2} units to (R²O)_{b}SiO_{(4-b)/2} units of 0.5:99.5 to 99.5 to 0.5 and the sum of HSiO_{3/2} units and (R²O)_{b}SiO_{(4-b)/2} units is at least 50 percent of the total siloxane units in the siloxane resin composition;
(B) heating the coated substrate for a time and temperature sufficient to effect curing of the coating composition, and
(C) further heating the coated substrate for a time and temperature sufficient to effect removal of the R²O groups from the cured coating composition, thereby forming an insoluble porous coating on the substrate.

16. The method as claimed in claim 15, where the heating in step (B) is from greater than 20° C. to 350° C. and the further heating in step (C) is from greater 350° C. to 600° C.

17. The method as claimed in claim 15, where the curing of the coating composition and removal of the R²O groups is done in a single step at a temperature from greater than 20° C. to 600° C.

18. The method as claimed in claim 17, where the temperature is from greater than 350° C. to 600° C.

19. The method as claimed in claim 15, wherein the insoluble porous coating has a porosity from 1 to 40 volume percent and a modulus from 4 to 80 GPa.

20. An electronic substrate having an insoluble porous coating prepared from the method of claim 13.
